(19) United States
(12) Patent Application Publication
(10) Pub. No.: US 2024/0004953 A1
(43) Pub. Date: Jan. 4, 2024

(54) COMPUTING ESTIMATED CLOSEST CORRELATION MATRICES

(71) Applicant: Microsoft Technology Licensing, LLC, Redmond, WA (US)

(72) Inventors: Bradley Curtis LACKEY, Redmond, WA (US); Andrew John MCGUINNESS, Thornhill (GB)

(73) Assignee: Microsoft Technology Licensing, LLC, Redmond, WA (US)

(21) Appl. No.: 17/810,249

(22) Filed: Jun. 30, 2022

(51) Int. Cl. G06F 17/15; G06Q 20/40

(52) U.S. Cl. CPC G06F 17/153; G06Q 20/4016; G06N 20/00

(57) ABSTRACT

A computing system is provided, including one or more processors configured to receive a plurality of input matrices M. Each input matrix M may include a plurality of estimated input correlation coefficients. The one or more processors may be further configured to compute a respective plurality of estimated closest correlation matrices X₀ for the plurality of input matrices M at a semidefinite program solver. Each estimated closest correlation matrix X₀ may be a positive definite matrix. The one or more processors may be further configured to generate a training data set including at least the plurality of estimated closest correlation matrices X₀. The one or more processors may be further configured to train a machine learning model using the training data set.

### BACKGROUND

A correlation matrix is a matrix in which the elements are correlation coefficients between pairs of random variables. Correlation matrices are symmetric and positive definite, and each element along the main diagonal of a correlation matrix is equal to 1. The correlation coefficients are within the interval [−1,1]. Using a correlation matrix, the correlations between the random variables may be expressed in a form that can be efficiently processed at a computing device.

### SUMMARY

According to one aspect of the present disclosure, a computing system is provided, including one or more processors configured to receive a plurality of input matrices M. Each input matrix M may include a plurality of estimated input correlation coefficients. The one or more processors may be further configured to compute a respective plurality of estimated closest correlation matrices X₀ for the plurality of input matrices M at a semidefinite program solver. Each estimated closest correlation matrix X₀ may be a positive definite matrix. The one or more processors may be further configured to generate a training data set including at least the plurality of estimated closest correlation matrices X₀. The one or more processors may be further configured to train a machine learning model using the training data set.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically shows an example computing environment at which correlation matrices may be generated, according to one example embodiment.

FIG. 2 schematically shows a computing system including one or more processors at which an estimated closest correlation matrix is computed, according to the example of FIG. 1.

FIG. 3 shows an example graphical user interface (GUI) at which a user may input a plurality of estimated input correlation coefficients, according to the example of FIG. 1.

FIG. 4 schematically shows the computing system when a semidefinite program solver is executed at the one or more processors, according to the example of FIG. 1.

FIG. 5 shows the example GUI of FIG. 3 when the estimated closest correlation matrix is displayed.

FIG. 6 schematically shows the computing system when a machine learning model is trained using a training data set that includes a plurality of estimated closest correlation matrices, according to the example of FIG. 1.

FIG. 7A shows a flowchart of an example method for use at a computing system to generate a training data set and train a machine learning model, according to the example of FIG. 1.

FIG. 7B shows steps of the method of FIG. 7A that may be performed in some examples when each of a plurality of estimated closest correlation matrices is computed.

FIG. 8 shows a schematic view of an example computing environment in which the computing system of FIG. 2 may be instantiated.

### DETAILED DESCRIPTION

In some applications, it may be useful to generate large numbers of correlation matrices. For example, as discussed in further detail below, the correlation matrices may be used as training data when training a machine learning model. It may be desirable to generate the correlation matrices such that the correlation coefficients encoded in them follow predefined distributions. However, existing methods of generating random or pseudorandom correlation matrices either have low computational efficiency or do not produce correlation matrices that follow predefined distributions of the correlation coefficients. Thus, it may be difficult to efficiently generate a training corpus of realistic correlation matrices using existing methods.

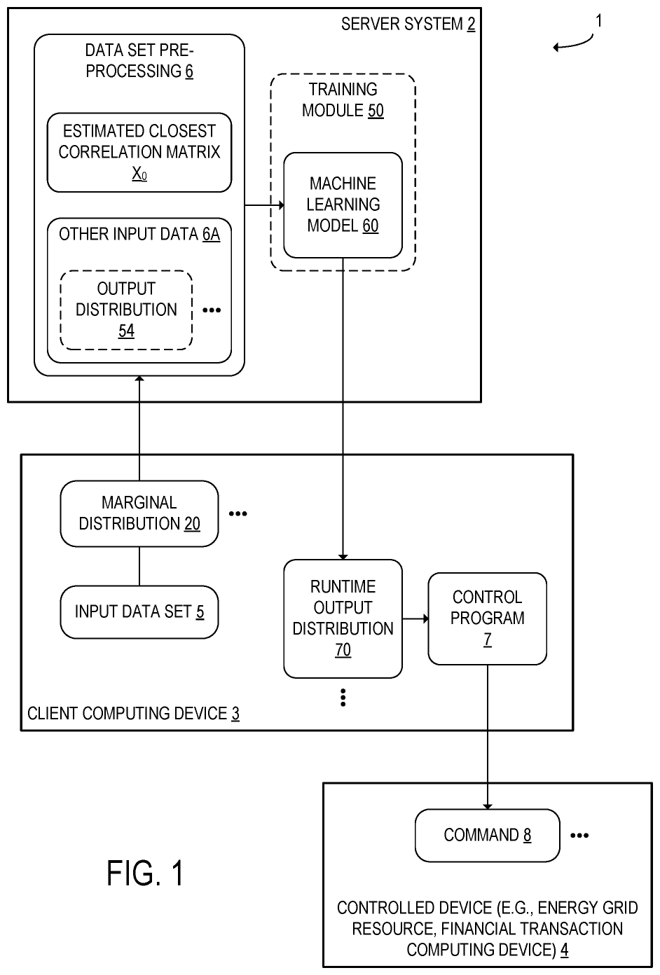

FIG. 1 schematically shows an example computing environment 1 at which correlation matrices may be generated in a manner that addresses the challenges discussed above. The computing environment 1 of FIG. 1 may include a server system 2, a client computing device 3, and a controlled device 4. At the client computing device 3, a plurality of marginal distributions 20 may be computed from an input data set 5 and transmitted to the server system 2. At the server system 2, pre-processing 6 may be performed to compute an estimated closest correlation matrix X₀. For example, for each of a plurality of sets of estimated input correlation coefficients (e.g., user-provided coefficients, empirically generated coefficients, or coefficients derived from a copula) the server system 2 may be configured to compute a respective estimated closest correlation matrix. The correlation coefficients may be within the interval [−1,1]. The estimated closest correlation matrix X₀ and, in some examples, other input data 6A may be input into machine learning model 60. The machine learning model 60 is shown in FIG. 1 during runtime, when the machine learning model 60 is configured to generate a plurality of runtime output distributions 70.

Alternatively, as discussed in further detail below, an estimated closest correlation matrix X₀ may be generated for inclusion in a training data set with which the machine learning model 60 is trained. In such examples, a training module 50 may be executed at the server system 2 and may receive additional training data as the other input data 6A. The other input data 6A may, in such examples, include a plurality of output distributions received from an additional computing process.

In examples in which the machine learning model 60 is executed at runtime, the server system may transmit the runtime output distributions 70 to the client computing device 3. Based at least in part on the runtime output distributions 70, the client computing device 3 may generate one or more commands 8 for the controlled device 4 at a control program 7. The controlled device 4 may, for example, be a device that is included in an energy grid and is configured to supply electrical power. As another example, the controlled device 4 may be a financial transaction computing device at which financial transactions may be programmatically performed. The controlled device 4 may be configured to programmatically execute the one or more commands 8 received from the client computing device 3.

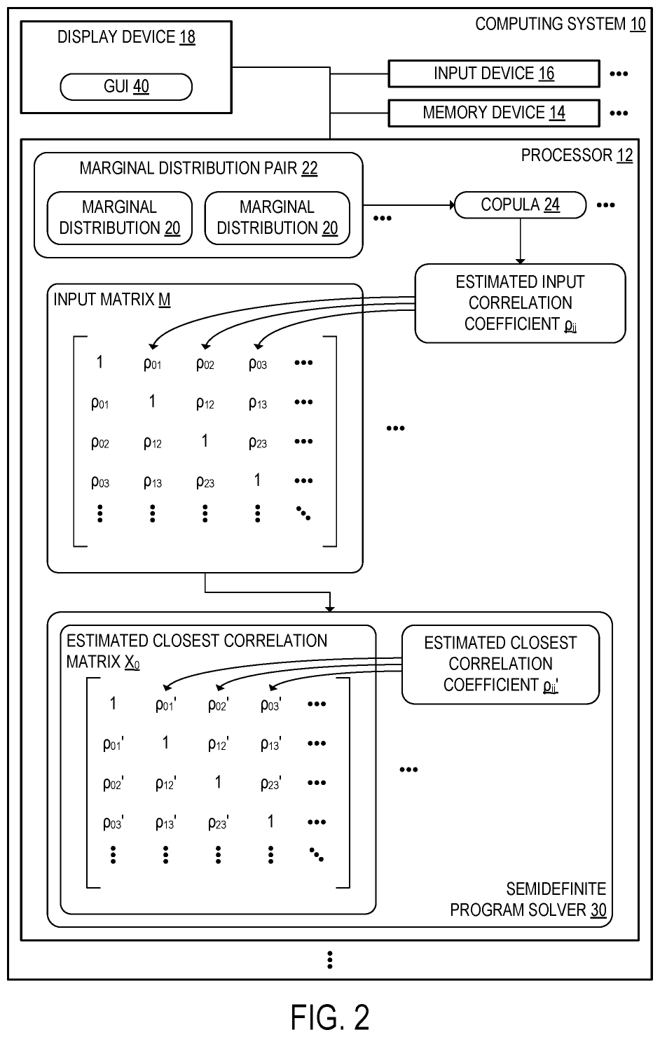

FIG. 2 schematically depicts a computing system 10 that may be included in the example computing environment 1 of FIG. 1. For example, the computing system 10 may instantiate the server system 2. The computing system 10 may include one or more processors 12 that are configured to execute instructions to perform computing processes. For example, the one or more processors 12 may include one or more central processing units (CPUs), graphical processing units (GPUs), field-programmable gate arrays (FPGAs), specialized hardware accelerators, and/or other types of processing devices. The computing system 10 may further include one or more memory devices 14 that are communicatively coupled to the one or more processors 12. The one or more memory devices 14 may, for example, include one or more volatile memory devices and/or one or more non-volatile memory devices.

The computing system 10 may be instantiated in a single physical computing device or in a plurality of communicatively coupled physical computing devices. For example, at least a portion of the computing system 10 may be provided as a server computing device located at a data center. In such examples, the computing system 10 may further include one or more client computing devices configured to communicate with the one or more server computing devices over a network.

The computing system 10 may further include one or more input devices 16 at which a user may enter user input to other components of the computing system 10. The one or more input devices 16 may, for example, include a keyboard, a mouse, a touchscreen, a microphone, an accelerometer, an optical sensor, and/or other types of input devices. In addition, the computing system 10 may further include one or more output devices, which may include a display device 18. One or more other types of output devices, such as a speaker or a haptic feedback device, may additionally or alternatively be included in the computing system 10. The display device 18 may be configured to display a graphical user interface (GUI) 40 at which the user may view outputs of computing processes executed at the one or more processors 12. The user may interact with the GUI 40 via the one or more input devices 16 to provide user input to the computing system 10.

The one or more processors 12 may be configured to receive a plurality of input matrices M. In some examples, the one or more processors 12 may be configured to receive the plurality of input matrices M via user input received at the GUI 40. In other examples, the plurality of input matrices M may be generated programmatically at one or more preliminary computing processes, as discussed in further detail below. Each input matrix M may include a plurality of estimated input correlation coefficients ρᵢⱼ. In some examples, the plurality of estimated input correlation coefficients ρᵢⱼ may indicate correlations between a plurality of pairs 22 of correlated random variables that have underlying marginal distributions 20. In the notation ρᵢⱼ for the estimated input correlation coefficients, i and j are respective indices in a list of the plurality of marginal distributions 20 for which the correlated random variables are included in the pair 22. Each input matrix M is a symmetric matrix in which ρᵢⱼ=ρⱼᵢ. In addition, when i=j, ρᵢⱼ=1.

In examples in which the plurality of input matrices M are received via user input at the GUI 40, the user may specify the estimated input correlation coefficients ρᵢⱼ at the GUI 40. In some examples, one or more of the estimated input correlation coefficients ρᵢⱼ included in an input matrix M may be specified at the GUI 40 via user input whereas one or more other estimated input correlation coefficients ρᵢⱼ included in the input matrix M may be computed synthetically.

The plurality of marginal distributions 20 may each have a respective independent variable and a respective dependent variable. The plurality of marginal distributions 20 may be derived from correlated empirical data and may therefore be correlated with each other. For example, the plurality of marginal distributions 20 may be derived from financial risk distributions such as distributions of loss risks to an insurer. Since some types of events (e.g. wildfires, floods, or earthquakes) may be causally upstream of multiple losses, the distributions of loss risks may be correlated with each other.

In another example, the plurality of marginal distributions may be energy source availability distributions. In this example, the plurality of marginal distributions 20 may include distributions for renewable energy sources such as wind, solar, and hydroelectric that depend upon weather conditions. Thus, the energy source availability distributions may also be derived from variates that are correlated with each other.

Other types of data may additionally or alternatively be included in the plurality of marginal distributions 20 in other examples. For example, the plurality of marginal distributions 20 may indicate energy demand data for a plurality of customers or geographic regions. As another example, the plurality of marginal distributions 20 may include supply data and/or demand data for participants in a manufacturing supply chain.

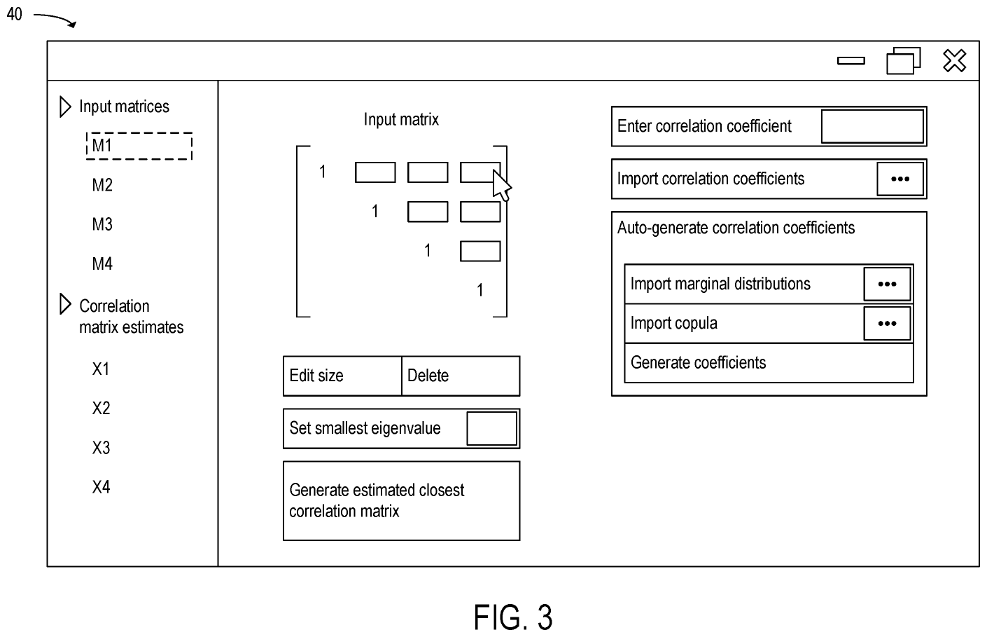

FIG. 3 shows an example of the GUI 40 that may be displayed when the user enters the input matrix M. As depicted in the example of FIG. 2, the GUI 40 may include a plurality of interactable elements at which the user may enter user input. The user may, for example, select an input matrix from among a plurality of input matrices. At the GUI 40, the user may also edit properties of the input matrix M such as its size and the values of the off-diagonal elements. The example GUI 40 shown in FIG. 3 includes a plurality of fillable fields at which the user may enter the estimated input correlation coefficients ρᵢⱼ as elements located above the main diagonal. Since the input matrix M is symmetric, the one or more processors 12 may be further configured to programmatically fill the elements of the input matrix M below the main diagonal with the values of the corresponding elements above the main diagonal.

At the example GUI 40 of FIG. 3, the user may also input instructions for the one or more processors 12 to import one or more of the estimated input correlation coefficients ρᵢⱼ from a source file. In addition, the example of FIG. 3 shows interactable elements at which the user may provide instructions to programmatically generate the estimated input correlation coefficients ρᵢⱼ of the input matrix M. When the user provides instructions to programmatically generate the estimated input correlation coefficients ρᵢⱼ, the user may, via interaction with the GUI 40, provide the one or more processors 12 with instructions to import the plurality of marginal distributions 20 from one or more marginal distribution source files. The user may additionally provide the one or more processors 12 with instructions to import a copula over two or more of the marginal distributions 20, as discussed in further detail below.

Returning to FIG. 2, in some examples, the one or more processors 12 may be configured to compute the estimated input correlation coefficients ρᵢⱼ based at least in part on a copula 24. The copula 24 may be a copula 24 whose dimension equals the number of the plurality of marginal distributions 20. For example, the copula 24 may be a Gaussian copula. In such examples, the one or more processors 12 may be configured to perform a probability integral transform on the plurality of marginal distributions 20 to compute the copula 24. In other examples, the copula 24 may some other type of copula such as a Clayton copula, a Gumbel copula, or a T copula. The copula 24 may encode the dependency structure of a joint distribution over the plurality of marginal distributions 20.

The one or more processors 12 may, in some examples, be configured to compute plurality of estimated input correlation coefficients ρᵢⱼ from empirical correlation data. In such examples, when the plurality of estimated input correlation coefficients ρᵢⱼ are computed using a copula 24, the copula 24 may be an empirical copula that includes empirical correlation data collected via experiments or observations of the system over which the marginal distributions 20 are defined. The copula 24 may further include a portion that is computed synthetically at the one or more processors 12. In examples in which the copula 24 is an empirical copula, the copula 24 may be defined at least in part by the user at the GUI 40.

When the estimated input correlation coefficients ρᵢⱼ are estimated based at least in part on the copula 24, the one or more processors 12 may be configured to sample the marginal distributions 20 included in each of the marginal distribution pairs 22 with the dependencies between the marginal distributions 20 indicated by the copula 24. The one or more processors 12 may be further configured to compute the estimated input correlation coefficients ρᵢⱼ between the samples of the marginal distributions 20. In some examples, the estimated input correlation coefficients ρᵢⱼ may be rank correlation coefficients.

One requirement for a matrix to be a mathematically valid correlation matrix is that the matrix is positive definite. However, an input matrix M in which the estimated input correlation coefficients ρᵢⱼ are input by the user or computed synthetically as discussed above is not guaranteed to be positive definite. The one or more processors 12 may therefore be further configured to modify the input matrix M to obtain a positive definite matrix.

Subsequently to receiving the plurality of input matrices M, the one or more processors 12 may be further configured to compute a respective plurality of estimated closest correlation matrices X₀ for the plurality of input matrices M. The plurality of estimated closest correlation matrices X₀ may be computed at a semidefinite program solver 30. Each of the estimated closest correlation matrices X₀ includes a respective plurality of estimated closest correlation coefficients ρᵢⱼ′. In order to be mathematically valid correlation matrices, each of the estimated closest correlation matrices X₀ has ρᵢⱼ′=ρⱼᵢ′. In addition, when i=j, ρᵢⱼ′=1.

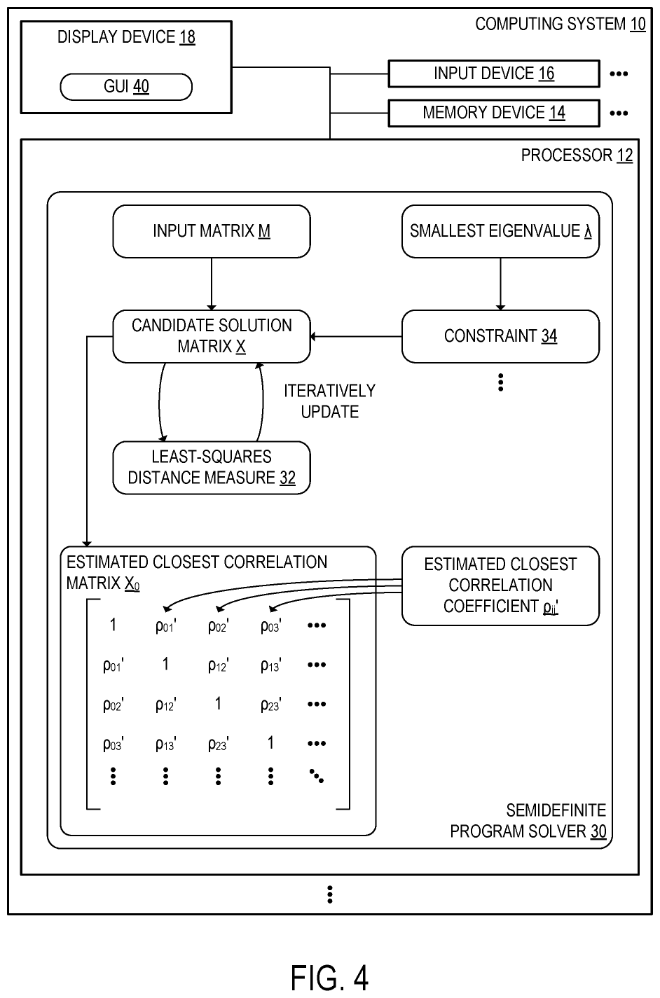

FIG. 4 shows the one or more processors 12 in additional detail when the semidefinite program solver 30 is executed to compute an estimated closest correlation matrix X₀. The semidefinite program solver 30 may be configured to receive the input matrix M for which the estimated closest correlation matrix X₀ is computed. The semidefinite program solver 30 may be further configured to receive a smallest eigenvalue λ of the estimated closest correlation matrix X₀. The smallest eigenvalue λ is a real number within (0,1). At the semidefinite program solver 30, the smallest eigenvalue λ may be used as a relaxation parameter that determines an amount of error allowed in the computation of the estimated closest correlation matrix X₀. In some examples, as depicted in FIG. 3, the smallest eigenvalue λ may be entered by the user at the GUI 40. Alternatively, the smallest eigenvalue λ may be programmatically selected. For example, a default value of the smallest eigenvalue λ may be used.

Returning to FIG. 4, at the semidefinite program solver 30, the one or more processors 12 may be configured to estimate the estimated closest correlation matrix X₀ to be the positive definite matrix closest to the input matrix M according to a least-squares distance measure 32. In one example, the one or more processors 12 may be configured to compute the respective estimated closest correlation matrix X₀ for the input matrix M at least in part by estimating a candidate solution matrix X that minimizes tr(MX). The one or more processors 12, in this example, may be configured to iteratively compute the value of tr(MX) for the candidate solution matrix X and update the candidate solution matrix X based at least in part on the computed value of tr(MX).

In some examples, rather than estimating a minimum value of tr(MX), the one or more processors 12 may be configured to instead estimate the estimated closest correlation matrix X₀ using some other algorithm such as the Higham algorithm. As another example, the Qi-Sun algorithm may be used to estimate X₀.

The one or more processors 12 may be further configured to subject the candidate solution matrix X to one or more constraints 34 when the estimated closest correlation matrix X₀ is computed. The one or more constraints 34 may include a constraint that the candidate solution matrix X is positive semidefinite. The one or more constraints 34 may further include a constraint that tr(AᵢX)=1−λ. In this constraint, Aᵢ is a square matrix in which each element is equal to 0 except a 1 located along a main diagonal of Aᵢ in an ith row. This constraint 34 is applied for each of the rows of the candidate solution matrix X. Accordingly, the diagonal elements of each candidate solution matrix X may each be equal to 1−λ. When the above constraint is applied, the smallest eigenvalue λ may function as a relaxation parameter. The smallest eigenvalue λ may be set to a high value by the user to allow for faster computation of the estimated closest correlation matrix X₀ at the cost of decreasing the accuracy of the estimate. Alternatively, the user may set the smallest eigenvalue λ to a low value to achieve greater accuracy at the cost of slower computation of X₀.

In order to set each of the diagonal elements of the estimated closest correlation matrix X₀ to 1 in the final result, the processor 12 may be further configured to add λI to the estimated closest correlation matrix X₀ after the estimated closest correlation coefficients have been computed, where I is an identity matrix.

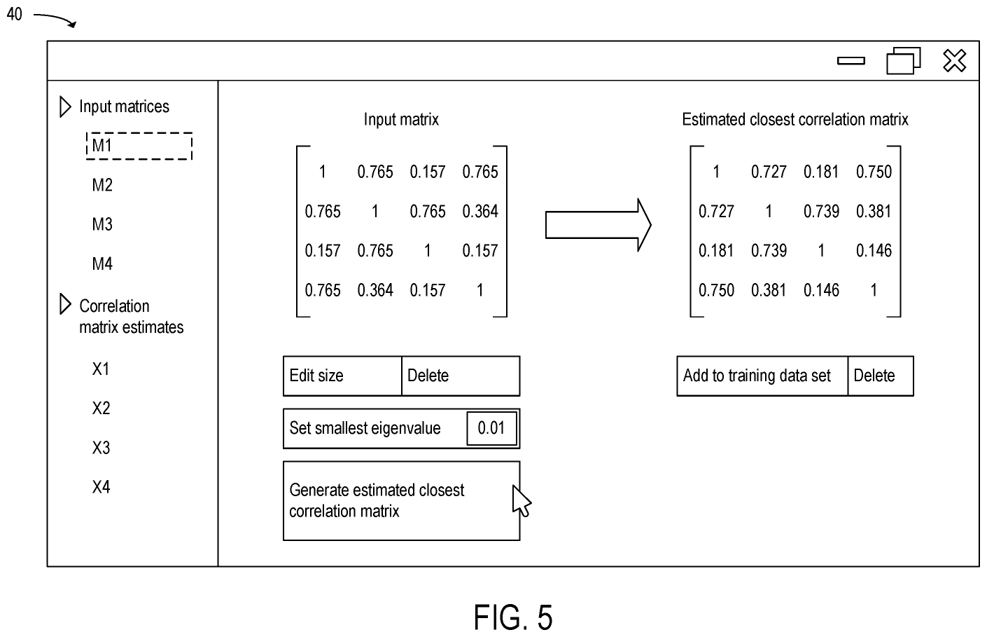

Subsequently to computing the estimated closest correlation matrix X₀, the one or more processors 12 may be further configured to output a graphical representation of the estimated closest correlation matrix X₀ for display at the GUI 40. FIG. 5 shows the example GUI 40 of FIG. 3 when the estimated closest correlation matrix X₀ generated for an input matrix M is displayed. In the example of FIG. 5, the user has set the smallest eigenvalue λ to 0.01. Accordingly, in the estimated closest correlation matrix X₀, each element along the main diagonal is initially set to 0.99 when computing the off-diagonal elements, and 0.01I is added to the solution to the estimated closest correlation matrix X₀ after the off-diagonal elements have been computed. As shown in the example of FIG. 5, the off-diagonal elements of the input matrix M have been modified to obtain values for those elements that minimize tr(MX) subject to the plurality of constraints 34. The GUI 40 as shown in FIG. 5 further includes an option to add the estimated closest correlation matrix X₀ to a training data set, as discussed in further detail below.

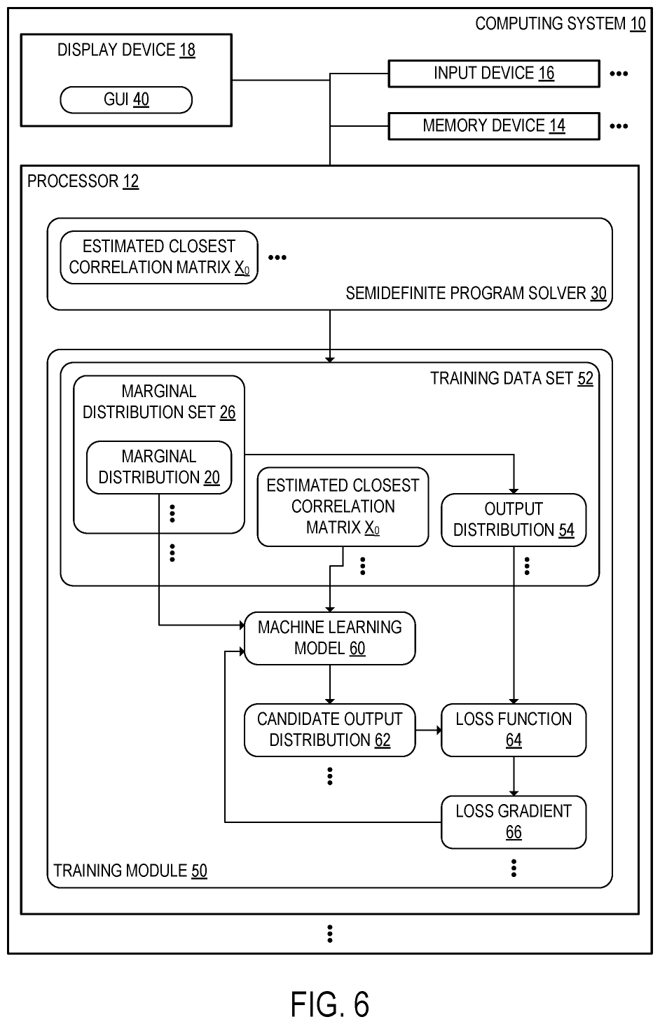

Subsequently to generating the plurality of estimated closest correlation matrices X₀ at the semidefinite program solver 30, the one or more processors 12 may be further configured to generate a training data set 52 including at least the plurality of estimated closest correlation matrices X₀, as depicted schematically in FIG. 6 according to one example. As shown in the example of FIG. 6, the training data set 52 may be generated at a training module 50 executed at the one or more processors 12. The training data set 52 may be used to train a machine learning model 60 at the training module 50.

In addition to the plurality of estimated closest correlation matrices X₀, the training data set 52 may further include the marginal distributions 20. The training data set 52 may, in some examples, further include a plurality of output distributions 54 associated with the estimated closest correlation matrices X₀ and the marginal distribution sets 26 for which the estimated closest correlation matrices X₀ are generated. The plurality of estimated closest correlation matrices X₀ may be paired with respective marginal distribution sets 26 such that each estimated closest correlation matrix X₀ is indicated in the training data set 52 as being paired with the marginal distribution set 26 with which that estimated closest correlation matrix X₀ was generated. Similarly, each of the plurality of output distributions 54 may be associated with a respective estimated closest correlation matrix X₀ and its corresponding marginal distribution set 26. Here, the training data set 52 may include a number of marginal distributions 20 equal to the number of dimensions in the matrix M. In particular, when multiple matrices M are provided as input, they may have the same size. This helps achieve the technical effect that the induced correlation in each pair of marginals will coincide with the associated correlation coefficient of the positive definite estimated closest correlation matrix X₀.

In some examples, the output distributions 54 may be outputs of another computing process that the machine learning model 60 is trained to simulate. Alternatively, the output distributions 54 may be empirical distributions of values measured for some physical system. In examples in which the output distributions 54 are empirical distributions, the output distributions 54 may be distributions of an output dependent variable when the dependent variable values included in the plurality of marginal distributions 20 are used as input parameters of an experiment performed at the physical system.

During training of the machine learning model 60 at the training module 50, the one or more processors 12 may be further configured to input the plurality of estimated closest correlation matrices X₀ and the plurality of marginal distributions 20 into the machine learning model 60. For example, the machine learning model 60 may be a deep neural network configured to receive, at an input layer, the estimated closest correlation matrices X₀ and the marginal distributions 20 included in the corresponding marginal distribution set 26. At the machine learning model 60, the one or more processors 12 may be further configured to generate a plurality of candidate output distributions 62. Each of the candidate output distributions 62 may be associated with the estimated closest correlation matrix X₀ and the marginal distribution set 26 that are used as inputs to the machine learning model 60 when the candidate output distribution 62 is generated.

The one or more processors 12 may be further configured to compute a value of a loss function 64 for the machine learning model 60 based at least in part on the plurality of candidate output distributions 62 and the corresponding output distributions 54. The loss function 64 may be a measure of a distance between a candidate output distribution 62 and an output distribution 54. The loss function 64 may be a measure of a distance (e.g. an L1 or L2 norm) between the candidate output distribution 62 and an output distribution 54. The one or more processors 12 may be further configured to compute a loss gradient 66 of the loss function 64 with respect to the parameters of the machine learning model 60 and to perform gradient descent at the machine learning model 60 to update its parameters. Thus, the one or more processors 12 may be configured to train the machine learning model 60 using the training data set 52 to simulate the process that generated the plurality of output distributions 54 included in the training data set 52.

In some examples, as shown in FIG. 1, the estimated closest correlation matrix X₀ may be used as a runtime input to the machine learning model 60 rather than as part of a training data set 52 for the machine learning model 60. The machine learning model 60 may, in such examples, be configured to perform inferencing to compute a runtime output based at least in part on the estimated closest correlation matrix X₀.

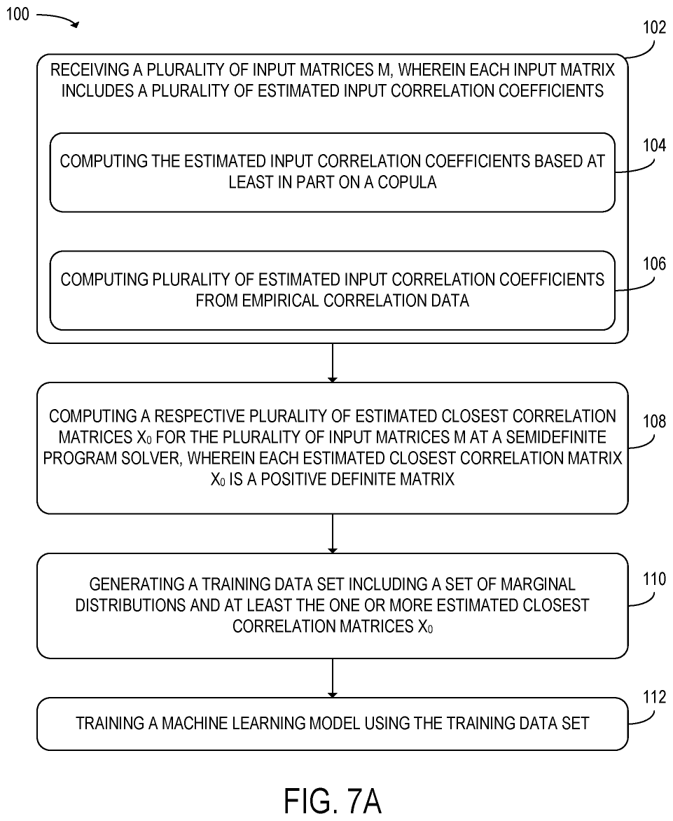

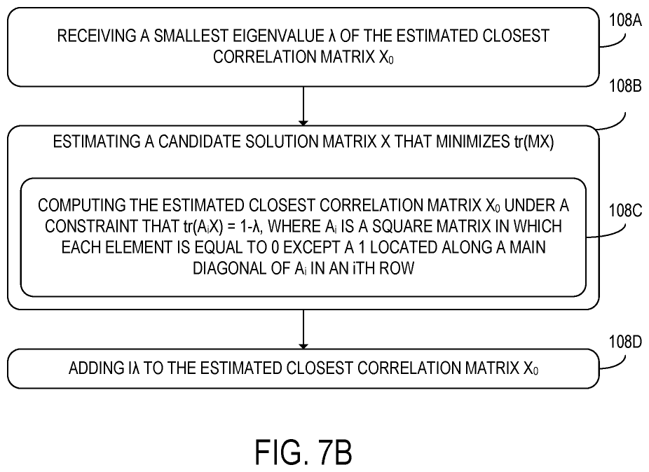

Turning now to FIG. 7A, a flowchart of an example method 100 for use with a computing system is shown. At step 102, the method 100 may include receiving a plurality of input matrices M at the computing system. Each input matrix M may include a plurality of estimated input correlation coefficients. The plurality of marginal distributions may, in such examples, be financial risk distributions or energy source availability distributions. Other types of marginal distributions, such as energy demand distributions or distributions of manufacturing supply chain data, may additionally or alternatively be used. In some examples, the plurality of estimated input correlation coefficients may be entered by a user at a GUI. Alternatively, the estimated input correlation coefficients may be derived from a copula or generated from empirical data at the computing system.

In some examples, at step 104, step 102 may include computing the estimated input correlation coefficients based at least in part on a copula. The copula used when computing the estimated input correlation coefficients may be a copula whose dimension equals the number of the plurality of marginal distributions 20. Additionally or alternatively, step 104 may include, at step 106, computing plurality of estimated input correlation coefficients from empirical correlation data. Different portions of the plurality of estimated input correlation coefficients may be received from different sources and/or computed according to different methods in some examples, such that the input matrix M is obtained through a combination of different approaches.

At step 108, the method 100 may further include computing a respective plurality of estimated closest correlation matrices X₀ for the plurality of input matrices M at a semidefinite program solver. Each estimated closest correlation matrix X₀ may be a positive definite matrix. Thus, when the input matrix M is not positive definite, a positive definite matrix close to M may be computed. Each estimated closest correlation matrix X₀ may be estimated to be the positive definite matrix closest to the corresponding input matrix M according to a least-squares distance measure. In other examples, some other distance measure may be used.

FIG. 7B shows additional steps of the method 100 that may be performed for each of the input matrices M in some examples when the estimated closest correlation matrices X₀ are computed at step 108. Step 108 may include, at step 108A, receiving a smallest eigenvalue λ of the estimated closest correlation matrix X₀. The smallest eigenvalue λ may, for example, be received via user input at the GUI. Alternatively, the estimated closest correlation matrix X₀ may be computed using a programmatically selected smallest eigenvalue λ, such as a default smallest eigenvalue λ.

At step 108B, step 108 may include estimating a candidate solution matrix X that minimizes tr(MX). The candidate solution matrix X may be iteratively updated to obtain the estimated closest correlation matrix X₀. Step 108B may include, at step 108C, computing the estimated closest correlation matrix X₀ under a constraint that tr(AᵢX)=1−λ. In this constraint, Aᵢ is a square matrix in which each element is equal to 0 except a 1 located along a main diagonal of Aᵢ in an ith row. Thus, the above constraint may specify that each of the diagonal elements of the candidate solution matrix X are equal to 1−λ. In addition, X₀ may be computed under a constraint that each candidate solution matrix X is positive semidefinite. At step 108D, step 108 may further include adding Iλ to the estimated closest correlation matrix X₀. Thus, the diagonal elements of the closest correlation matrix X₀ may each be set to 1.

Returning to FIG. 7A, subsequently to generating the estimated closest correlation matrices X₀ at step 108, the method 100 may further include, at step 110, generating a training data set including at least the plurality of estimated closest correlation matrices X₀. In some examples, the training data set may further include the marginal distributions included in the plurality of pairs of marginal distributions, which may be organized into a plurality of marginal distribution sets respectively associated with the plurality of estimated closest correlation matrices X₀. Each of the marginal distribution sets may include the plurality of marginal distributions for which the corresponding estimated closest correlation matrix X₀ was generated. The training data set may further include, in some examples, a plurality of output distributions. Each of the output distributions may be a distribution of the outputs of a computational or physical process when that process receives inputs given by a corresponding marginal distribution set and a corresponding estimated closest correlation matrix X₀. The marginal distribution set and the estimated closest correlation matrix X₀ may, for example, be the inputs received at a target model at which a corresponding output distribution is computed. Alternatively, the marginal distribution set and the estimated closest correlation matrix X₀ may be observed inputs to a physical process in some examples.

At step 112, the method 100 may further include training a machine learning model using the training data set. In examples in which the training data set further includes a plurality of output distributions, as discussed above, the machine learning model may be trained to simulate the computational or physical process for which the plurality of output distributions are generated.

Using the systems and methods discussed above, estimated closest correlation matrices that approximate input matrices may be generated for sets of marginal distributions. Estimating correlation matrices in this manner may allow a user to more efficiently generate training data sets that include large numbers of correlation matrices. Accordingly, the systems and methods discussed above may facilitate the training of machine learning models that are configured to receive correlations as inputs.

In some embodiments, the methods and processes described herein may be tied to a computing system of one or more computing devices. In particular, such methods and processes may be implemented as a computer-application program or service, an application-programming interface (API), a library, and/or other computer-program product.

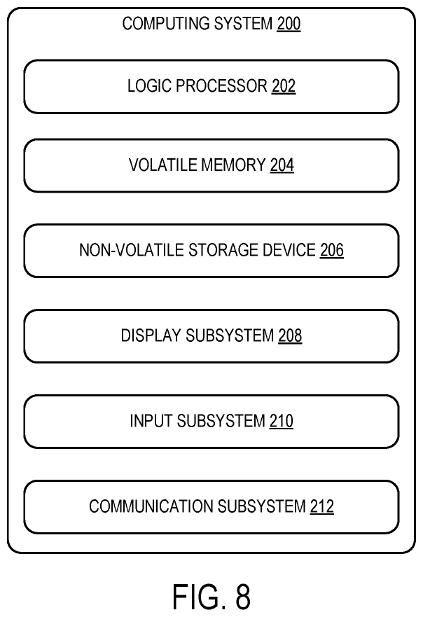

FIG. 8 schematically shows a non-limiting embodiment of a computing system 200 that can enact one or more of the methods and processes described above. Computing system 200 is shown in simplified form. Computing system 200 may embody the computing system 10 described above and illustrated in FIG. 2. Components of the computing system 200 may be instantiated in one or more personal computers, server computers, tablet computers, home-entertainment computers, network computing devices, video game devices, mobile computing devices, mobile communication devices (e.g., smart phone), and/or other computing devices, and wearable computing devices such as smart wristwatches and head mounted augmented reality devices.

Computing system 200 includes a logic processor 202 volatile memory 204, and a non-volatile storage device 206. Computing system 200 may optionally include a display subsystem 208, input subsystem 210, communication subsystem 212, and/or other components not shown in FIG. 8.

Logic processor 202 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 202 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Volatile memory 204 may include physical devices that include random access memory. Volatile memory 204 is typically utilized by logic processor 202 to temporarily store information during processing of software instructions. It will be appreciated that volatile memory 204 typically does not continue to store instructions when power is cut to the volatile memory 204.

Non-volatile storage device 206 includes one or more physical devices configured to hold instructions executable by the logic processors to implement the methods and processes described herein. When such methods and processes are implemented, the state of non-volatile storage device 206 may be transformed—e.g., to hold different data.

Non-volatile storage device 206 may include physical devices that are removable and/or built-in. Non-volatile storage device 206 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 206 may include nonvolatile, dynamic, static, read/write, read-only, sequential-access, location-addressable, file-addressable, and/or content-addressable devices. It will be appreciated that non-volatile storage device 206 is configured to hold instructions even when power is cut to the non-volatile storage device 206.

Aspects of logic processor 202, volatile memory 204, and non-volatile storage device 206 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 200 typically implemented in software by a processor to perform a particular function using portions of volatile memory, which function involves transformative processing that specially configures the processor to perform the function. Thus, a module, program, or engine may be instantiated via logic processor 202 executing instructions held by non-volatile storage device 206, using portions of volatile memory 204. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 208 may be used to present a visual representation of data held by non-volatile storage device 206. The visual representation may take the form of a graphical user interface (GUI). As the herein described methods and processes change the data held by the non-volatile storage device, and thus transform the state of the non-volatile storage device, the state of display subsystem 208 may likewise be transformed to visually represent changes in the underlying data. Display subsystem 208 may include one or more display devices utilizing virtually any type of technology. Such display devices may be combined with logic processor 202, volatile memory 204, and/or non-volatile storage device 206 in a shared enclosure, or such display devices may be peripheral display devices.

When included, input subsystem 210 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 212 may be configured to communicatively couple various computing devices described herein with each other, and with other devices. Communication subsystem 212 may include wired and/or wireless communication devices compatible with one or more different communication protocols. As non-limiting examples, the communication subsystem may be configured for communication via a wireless telephone network, or a wired or wireless local- or wide-area network, such as a HDMI over Wi-Fi connection. In some embodiments, the communication subsystem may allow computing system 200 to send and/or receive messages to and/or from other devices via a network such as the Internet.

The following paragraphs discuss several aspects of the present disclosure. According to one aspect of the present disclosure, a computing system is provided, including one or more processors configured to receive a plurality of input matrices M. Each input matrix M may include a plurality of estimated input correlation coefficients. The one or more processors may be further configured to compute a respective plurality of estimated closest correlation matrices X₀ for the plurality of input matrices M at a semidefinite program solver. Each estimated closest correlation matrix X₀ may be a positive definite matrix. The one or more processors may be further configured to generate a training data set including at least the plurality of estimated closest correlation matrices X₀. The one or more processors may be further configured to train a machine learning model using the training data set. A potential technical advantage of such a configuration is that valid correlation matrices may be programmatically generated as training data for a machine learning model that is configured to receive correlation data as input.

According to this aspect, the one or more processors may be configured to estimate each estimated closest correlation matrix X₀ to be the positive definite matrix closest to the corresponding input matrix M according to a least-squares distance measure. A potential technical advantage of such a configuration is that the estimated closest correlation matrix may be estimated numerically when it would be infeasible to compute an exact closest correlation matrix.

According to this aspect, at the semidefinite program solver, the one or more processors may be configured to compute the respective estimated closest correlation matrix X₀ for each of the input matrices M at least in part by estimating a candidate solution matrix X that minimizes tr(MX). A potential technical advantage of such a configuration is that tr(MX) may be used as an objective function for the semidefinite program solver.

According to this aspect, at the semidefinite program solver, the one or more processors may be further configured to receive a smallest eigenvalue λ of the estimated closest correlation matrix X₀. The one or more processors may be further configured to compute the estimated closest correlation matrix X₀ under a constraint that tr(AᵢX)=1−λ, where Aᵢ is a square matrix in which each element is equal to 0 except a 1 located along a main diagonal of Aᵢ in an ith row. A potential technical advantage of such a configuration is that the smallest eigenvalue may be used as a parameter of the semidefinite program solver to set a user-specified accuracy level.

According to this aspect, the one or more processors may be configured to receive the plurality of input matrices M via user input at a graphical user interface (GUI). A potential technical advantage of such a configuration is that the user may specify the plurality of input matrices used to generate the closest estimated correlation matrices.

According to this aspect, the one or more processors may be configured to compute the estimated input correlation coefficients based at least in part on a copula. A potential technical advantage of such a configuration is that the estimated input correlation coefficients may be generated for a plurality of correlated marginal distributions with correlations specified by the copula.

According to this aspect, the one or more processors may be configured to compute a plurality of estimated input correlation coefficients from empirical correlation data. A potential technical advantage of such a configuration is that the estimated input correlation coefficients may be generated to reflect empirically observed processes.

According to this aspect, the training data set may further include a plurality of marginal distributions. A potential technical advantage of such a configuration is that the machine learning model may be trained to model the correlations between the marginal distributions.

According to this aspect, the plurality of marginal distributions may be financial risk distributions. A potential technical advantage of such a configuration is that the machine learning model may be trained to model correlated financial risks.

According to this aspect, the plurality of marginal distributions may be energy source availability distributions. A potential technical advantage of such a configuration is that the machine learning model may be trained to model correlated energy sources.

According to another aspect of the present disclosure, a method for use with a computing system is provided. The method may include receiving a plurality of input matrices M. Each input matrix M may include a plurality of estimated input correlation coefficients. The method may further include computing a respective plurality of estimated closest correlation matrices X₀ for the plurality of input matrices M at a semidefinite program solver. Each estimated closest correlation matrix X₀ may be a positive definite matrix. The method may further include generating a training data set including at least the plurality of estimated closest correlation matrices X₀. The method may further include training a machine learning model using the training data set. A potential technical advantage of such a configuration is that valid correlation matrices may be programmatically generated as training data for a machine learning model that is configured to receive correlation data as input.

According to this aspect, each estimated closest correlation matrix X₀ may be estimated to be the positive definite matrix closest to the corresponding input matrix M according to a least-squares distance measure. A potential technical advantage of such a configuration is that the estimated closest correlation matrix may be estimated numerically when it would be infeasible to compute an exact closest correlation matrix.

According to this aspect, at the semidefinite program solver, the respective estimated closest correlation matrix X₀ may be computed for each of the input matrices M at least in part by estimating a candidate solution matrix X that minimizes tr(MX). A potential technical advantage of such a configuration is that tr(MX) may be used as an objective function for the semidefinite program solver.

According to this aspect, the method may further include, at the semidefinite program solver, receiving a smallest eigenvalue λ of the estimated closest correlation matrix X₀. The method may further include, at the semidefinite program solver, computing the estimated closest correlation matrix X₀ under a constraint that tr(AᵢX)=1−λ, where Aᵢ is a square matrix in which each element is equal to 0 except a 1 located along a main diagonal of Aᵢ in an ith row. A potential technical advantage of such a configuration is that the smallest eigenvalue may be used as a parameter of the semidefinite program solver to set a user-specified accuracy level.

According to this aspect, the plurality of input matrices M may be received via user input at a graphical user interface (GUI). A potential technical advantage of such a configuration is that the user may specify the plurality of input matrices used to generate the closest estimated correlation matrices.

According to this aspect, the method may further include computing the estimated input correlation coefficients based at least in part on a copula. A potential technical advantage of such a configuration is that the estimated input correlation coefficients may be generated for a plurality of correlated marginal distributions with correlations specified by the copula.

According to this aspect, the method may further include computing a plurality of estimated input correlation coefficients from empirical correlation data. A potential technical advantage of such a configuration is that the estimated input correlation coefficients may be generated to reflect empirically observed processes.

According to this aspect, the training data set may further include a plurality of marginal distributions. A potential technical advantage of such a configuration is that the machine learning model may be trained to model the correlations between the marginal distributions.

According to this aspect, the plurality of marginal distributions may be financial risk distributions or energy source availability distributions. A potential technical advantage of such a configuration is that the machine learning model may be trained to model correlated financial risks or energy sources.

According to another aspect of the present disclosure, a computing system is provided, including one or more processors configured to, at a graphical user interface (GUI), receive a user input specifying an input matrix M that includes a plurality of estimated input correlation coefficients. At the GUI, the one or more processors may be further configured to receive a smallest eigenvalue λ for an estimated closest correlation matrix X₀. The one or more processors may be further configured to compute the estimated closest correlation matrix X₀ for the input matrix M at a semidefinite program solver. The estimated closest correlation matrix X₀ may be a positive definite matrix and has the smallest eigenvalue λ. The one or more processors may be further configured to output a graphical representation of the estimated closest correlation matrix X₀ for display at the GUI. A potential technical advantage of such a configuration is that valid correlation matrices may be programmatically generated from user-specified estimated closest correlation matrices.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system comprising:
one or more processors configured to:
receive a plurality of input matrices M, wherein each input matrix M includes a plurality of estimated input correlation coefficients;
compute a respective plurality of estimated closest correlation matrices X₀ for the plurality of input matrices M at a semidefinite program solver, wherein each estimated closest correlation matrix X₀ is a positive definite matrix;
generate a training data set including at least the plurality of estimated closest correlation matrices X₀; and
train a machine learning model using the training data set.

2. The computing system of claim 1, wherein the one or more processors are configured to estimate each estimated closest correlation matrix X₀ to be the positive definite matrix closest to the corresponding input matrix M according to a least-squares distance measure.

3. The computing system of claim 2, wherein, at the semidefinite program solver, the one or more processors are configured to compute the respective estimated closest correlation matrix X₀ for each of the input matrices M at least in part by estimating a candidate solution matrix X that minimizes tr(MX).

4. The computing system of claim 3, wherein, at the semidefinite program solver, the one or more processors are further configured to:
receive a smallest eigenvalue λ of the estimated closest correlation matrix X₀; and
compute the estimated closest correlation matrix X₀ under a constraint that tr(AᵢX)=1−λ, where Aᵢ is a square matrix in which each element is equal to 0 except a 1 located along a main diagonal of Aᵢ in an ith row.

5. The computing system of claim 1, wherein the one or more processors are configured to receive the plurality of input matrices M via user input at a graphical user interface (GUI).

6. The computing system of claim 1, wherein the one or more processors are configured to compute the estimated input correlation coefficients based at least in part on a copula.

7. The computing system of claim 1, wherein the one or more processors are configured to compute a plurality of estimated input correlation coefficients from empirical correlation data.

8. The computing system of claim 1, wherein the training data set further includes a plurality of marginal distributions.

9. The computing system of claim 1, wherein the plurality of marginal distributions are financial risk distributions.

10. The computing system of claim 1, wherein the plurality of marginal distributions are energy source availability distributions.

11. A method for use with a computing system, the method comprising:
receiving a plurality of input matrices M, wherein each input matrix M includes a plurality of estimated input correlation coefficients;
computing a respective plurality of estimated closest correlation matrices X₀ for the plurality of input matrices M at a semidefinite program solver, wherein each estimated closest correlation matrix X₀ is a positive definite matrix;
generating a training data set including at least the plurality of estimated closest correlation matrices X₀; and
training a machine learning model using the training data set.

12. The method of claim 11, wherein each estimated closest correlation matrix X₀ is estimated to be the positive definite matrix closest to the corresponding input matrix M according to a least-squares distance measure.

13. The method of claim 12, wherein, at the semidefinite program solver, the respective estimated closest correlation matrix X₀ is computed for each of the input matrices M at least in part by estimating a candidate solution matrix X that minimizes tr(MX).

14. The method of claim 13, further comprising, at the semidefinite program solver:
receiving a smallest eigenvalue λ of the estimated closest correlation matrix X₀; and
computing the estimated closest correlation matrix X₀ under a constraint that tr(AᵢX)=1−λ, where Aᵢ is a square matrix in which each element is equal to 0 except a 1 located along a main diagonal of Aᵢ in an ith row.

15. The method of claim 11, wherein the plurality of input matrices M are received via user input at a graphical user interface (GUI).

16. The method of claim 11, further comprising computing the estimated input correlation coefficients based at least in part on a copula.

17. The method of claim 11, further comprising computing a plurality of estimated input correlation coefficients from empirical correlation data.

18. The method of claim 11, wherein the training data set further includes a plurality of marginal distributions.

19. The method of claim 11, wherein the plurality of marginal distributions are financial risk distributions or energy source availability distributions.

20. A computing system comprising:
one or more processors configured to:
at a graphical user interface (GUI), receive:
a user input specifying an input matrix M that includes a plurality of estimated input correlation coefficients; and
a smallest eigenvalue λ for an estimated closest correlation matrix X₀;
compute the estimated closest correlation matrix X₀ for the input matrix M at a semidefinite program solver, wherein the estimated closest correlation matrix X₀ is a positive definite matrix and has the smallest eigenvalue λ; and
output a graphical representation of the estimated closest correlation matrix X₀ for display at the GUI.
